(19) United States
(12) Patent Application Publication
(10) Pub. No.: US 2013/0114320 A1
(43) Pub. Date: May 9, 2013

(54) DEVICE FOR BALANCING THE VOLTAGE ON THE TERMINALS OF A CAPACITOR OF A SET OF CAPACITORS, AND VOLTAGE CONVERSION SYSTEM INCLUDING SUCH A BALANCING DEVICE

(71) Applicant: Alfred Permuy, Rueil Malmaison (FR)

(72) Inventor: Alfred Permuy, Rueil Malmaison (FR)

(73) Assignee: GE Energy Power Conversion Technology Ltd., Warwickshire (GB)

(21) Appl. No.: 13/810,306

(22) PCT Filed: Jul. 15, 2011
(86) PCT No.: PCT/FR11/51697

§ 371 Date: Jan. 15, 2013

(30) Foreign Application Priority Data
Jul. 16, 2010 (FR) 10 55790

(51) Int. Cl. H02J 7/00; H02M 7/539

(52) U.S. Cl. CPC H02J 7/00; H02M 7/539
USPC 363/131; 320/166

(57) ABSTRACT

Device for balancing voltage on terminals of at least one capacitor of a set of N−1 capacitors connected in series between a positive terminal and a negative input terminal and connected through intermediate points, comprising at least one balancing module connected between both input terminals; each balancing module including means for determining the amount of excess or lacking charges in the intermediate points, a temporary electric energy storage element including two terminals, first current guiding means to extract electric charges from an intermediate point towards a terminal of the storage element, second current guiding means to inject electric charges from the other terminal of the storage element towards an intermediate point, and a member able to control the first means so as to extract charges from at least one intermediate point and able to control the second means so as to inject the charges to at least one intermediate point.

### CROSS REFERENCES TO RELATED APPLICATIONS

This application is a national phase entry of PCT/FR2011/051697 entitled DISPOSITIF D'ÉQUILIBRAGE DE LA TENSION AUX BORNES D'UN CONDENSATEUR D'UN ENSEMBLE DE CONDENSATEURS, ET SYSTÈME DE CONVERSION DE TENSION COMPORTANT UN TEL DISPOSITIF D'ÉQUILIBRAGE, filed on Jul. 15, 2011 by inventor Alfred Permuy.

PCT/FR2011/051697 claims priority benefit of French Patent Application No. 10 55790 filed on Jul. 16, 2010.

### FIELD OF THE INVENTION

The field of the present invention is voltage balancing and conversion.

### BACKGROUND OF THE INVENTION

The present invention relates to a device for balancing the voltage on the terminals of at least one capacitor of a set of capacitors, said set of capacitors comprising a positive input terminal, a negative input terminal, N−1 capacitors connected in series between both input terminals and connected together through intermediate points, two extreme capacitors of N−1 capacitors being directly connected to one of the two input terminals, N being greater than or equal to 3, both input terminals and the intermediate points being able to be connected to an electric energy conversion device which may cause an unbalance of the voltage on the terminals of at least one capacitor.

The invention also relates to a voltage conversion system comprising such a balancing device.

The invention also relates to a method for balancing the voltage on the terminals of a capacitor of a set of capacitors.

A voltage inverter with three levels is known comprising a positive input terminal, a negative input terminal and an output terminal for said or each phase of the alternating current delivered at the output of the inverter, and two capacitors connected in series between the positive terminal and the negative terminal, both capacitors being connected together through a middle point. The inverter comprises, for each output terminal, a module for switching the input DC voltage, each switching module being connected between both input terminals and the respective output terminal. When the voltage and the current at the output of the inverter are symmetrical relatively to the middle point, the balance of the electric charges at the middle point is zero over one period of the alternating current.

However, the value of the capacitance of the capacitors should be sufficiently high in order to limit the voltage variation at the middle point during one period of the alternating current, which generates the use of capacitors with significant size and costs, when the output alternating current is a low frequency current.

A voltage inverter with N levels is also known, wherein N is an integer greater than three, comprising a positive input terminal, a negative input terminal, an output terminal for said or each phase of the output alternating current, and a set of capacitors including N−1 capacity connected in series between both input terminals and connected together through intermediate points, two extreme capacitors of the N−1 capacitors being directly connected to one of the two input terminals. The N-level voltage inverter comprises, for each output terminal, a module for switching the input DC voltage, each switching module being connected between both input terminals and the respective output terminal. The N-level voltage inverter also comprises means for balancing the voltage on the terminals of each of the N−1 capacitors by adding a common mode homopolar component on each of the phases of the output alternating current, the shift between the phases allowing charging or discharging of the capacitors.

However, such balancing means are efficient when the amplitude of the alternating output voltage is less than a limiting value substantially equal to the quarter of the value of the input DC voltage. The balancing means do not allow proper balancing of the electric charges on the terminals of said capacitors when the amplitude of the output alternating current is greater than the aforementioned limiting value, while the advantage of multilevel voltage invertors is to deliver an alternating current having a high voltage amplitude.

### SUMMARY OF THE DESCRIPTION

The object of the invention is to propose a balancing device allowing balancing of the voltage in each of the intermediate points of the set of capacitors regardless of the voltage and of the current delivered by the conversion device able to be connected between the input terminals.

For this purpose, the object of the invention is a balancing device of the aforementioned type, characterized in that it comprises at least one module for balancing the voltage on the terminals of each of the N−1 capacitors, the balancing module being connected between both input terminals and including means for determining the amount of excess charges or lacking charges in each of the intermediate points, a temporary electric energy storage element including two terminals, first current guiding means capable of extracting electric charges from an intermediate point towards a terminal of the temporary storage element, second current guiding means capable of injecting electric charges from the other terminal of the temporary storage element towards an intermediate point, and a unit for controlling the first and second guiding means capable of controlling the first guiding means so as to extract charges from at least one intermediate point having an excess of charges and the second guiding means so as to inject the charges to at least one intermediate point having a lack of charges, and

in that a terminal of the temporary storage element is able to be connected to the positive input terminal, respectively to the negative input terminal, via the first guiding means and the other terminal of the temporary storage element is able to be connected to the negative input terminal, respectively to the positive input terminal, via the second guiding means, in order to increase, respectively reduce, the energy stored in the temporary storage element.

According to other embodiments, the balancing device comprises one or more of the following features, taken individually or according to all technically possible combinations:
the temporary storage element includes at least one electromagnetic coil,
each of the first and second guiding means include N−1 switches and N−1 diodes,
the switches of the first means are connected in series between the positive input terminal and a terminal of the storage element, and connected together through connection points, two extreme switches of the N−1 switches being directly connected to one of the two terminals from among the positive terminal and the storage element terminal, N−2 diodes of the first means are forwardly connected between a respective intermediate point and a respective connection point of the first means, and the other diode of the first means is forwardly connected between the negative input terminal and the storage element terminal, and
the switches of the second means are connected in series between the negative input terminal and the other terminal of the storage element, and connected together through connection points, two extreme switches of the N−1 switches being directly connected to one of the two switches from among the negative terminal and the other storage element terminal, N−2 diodes of the second means are reversely connected between a respective intermediate point and a respective connection point of the second means, and the other diode of the second means is reversely connected between the positive input terminals and the other terminal of the storage element,
the switches of the first means are connected in parallel between the terminal of the storage element and a point from among the positive input terminal and the intermediate points, N−2 diodes of the first means are connected in series with said switches connected between the terminal of the storage element and the intermediate points and forwardly between the intermediate points and the terminals, and the other diode of the first means is forwardly connected between the negative input terminals and the terminal of the storage element, and
the switches of the second means are connected in parallel between the other terminal of the storage element and a point from among the negative input terminals and the intermediate points, N−2 diodes of the second means are connected in series with said switches connected between the other terminal of the storage element and the intermediate points and reversely between the intermediate points and the other terminal, and the other diodes of the second means is reversely connected between the positive input terminal and the other terminal of the storage element,
the means for determining the amount of excess charges or lacking charges include means for measuring the voltage on the input terminals and on each of the intermediate points.

The object of the invention is also a system for converting an input DC voltage into an output AC voltage including at least one phase, comprising:
a positive input terminal, a negative input terminal and an output terminal for said or each phase,
a set of capacitors including N−1 capacitors connected in series between both input terminals and connected together through intermediate points, two extreme capacitors of the N−1 capacitors being directly connected to one of the two input terminals, N being greater than or equal to 3,
for each output terminal, an input DC voltage switching module, each switching module being connected between both input terminals and the respective output terminal, and being able to convert the input DC voltage into the respective phase of the output AC voltage,
means for controlling each switching module,

characterized in that it comprises a balancing device according to any of the preceding claims, the balancing device being connected between both input terminals.

According to other embodiments, the conversion system comprises one or more of the following features, taken individually or according to all the technically possible combinations:
the switching module comprises two extreme branches and N−2 intermediate branches, each extreme branch is connected between a respective input terminal and said output terminal, and includes N−1 switches connected in series and connected together through middle points, and each intermediate branch is connected to a respective intermediate point and includes two diodes, the first diode being forwardly connected to said respective intermediate point and a respective middle point of one of the two extreme branches, and the second diode being reversely connected between said respective intermediate point and a respective middle point of the other one of the two extreme branches,
the switching module comprises two extreme branches and N−2 intermediate branches, each extreme branch includes a switch connected between a respective input terminal and said output terminal, and each intermediate branch includes two switches connected in anti-series between a respective intermediate point and said output terminal.

The object of the invention is also a method for balancing the voltage on the terminals of a capacitor of a set of capacitors, via a device for balancing said voltage,
said set of capacitors comprising a positive input terminal, a negative input terminal, N−1 capacitors connected in series between both input terminals and connected together through intermediate points, two extreme capacitors of the N−1 capacitors being directly connected to one of the two input terminals, N being greater than or equal to 3, both input terminals and the intermediate points being capable of being connected to an electric energy conversion device which may cause an unbalance of the voltage on the terminals of at least one capacitor,

the balancing device comprising at least one balancing module connected between both input terminals and including means for determining the amount of excess or lacking charges in each of the intermediate points, a temporary electric energy storage element including two terminals, first current guiding means capable of extracting electric charges from an intermediate point towards a terminal of the temporary storage element, and second current guiding means capable of injecting electric charges from the other terminal of the temporary storage element towards an intermediate point,

the method comprising:
a step for establishing a current in the temporary storage element until the value of said current is greater than a reference value, during which a terminal of the temporary storage element is connected to the positive input terminal via a corresponding control of the first guiding means, the other terminal of the temporary storage element being connected to the negative input terminal via a corresponding control of the second guiding means,
a step for determining an intermediate point with an excess of electric charges and/or another intermediate point lacking electric charges,
a step for extracting charges from the intermediate point with an excess of charges intended for the temporary storage element, via corresponding control of the first guiding means, and/or
a step for injecting charges into the intermediate point lacking charges from the temporary storage element, via a corresponding control of the second guiding means,
a step for measuring the current in the temporary storage element at the end of at least one charge extraction and/or injection step, and
a step for discharging the temporary storage element when the value of the current measured during the measurement step is greater than that of the reference value.

According to other embodiments, the balancing method comprises one or more of the following features, taken individually or according to all the technically possible combinations:
each of the first and second guiding means include N−1 switches and N−1 diodes,

the switches of the first means being connected in series between the positive input terminal and a terminal of the storage element, and connected together through connection points, two extreme switches of the N−1 switches being directly connected to one of the two terminals from among the positive terminal and the terminal of the storage element, N−2 diodes of the first means being forwardly connected between a respective intermediate point and a respective connection point of the first means, and the other diode of the first means being forwardly connected between the negative input terminal and the terminal of the storage element,

the switches of the second means being connected in series between the negative input terminal and the other terminal of the storage element, and connected together through connection points, two extreme switches of the N−1 switches being directly connected to one of the two terminals from among the negative terminal and the other terminal of the storage element, N−2 diodes of the second means being reversely connected between a respective intermediate point and a respective connection point of the second means, and the other diode of the second means being reversely connected between the positive input terminal and the other terminal of the storage element,

during the initial step for establishing the current in the temporary storage element, all the switches of the first and second guiding means are closed,

during the step for extracting charges, the diode of the first guiding means forwardly connected to the intermediate point with an excess of charges is conducting, said switch(es) of the first means being positioned between said conducting diodes of the first means and the storage element being closed, the other switches of the first and second guiding means being open,

during the step for injection of charges, the diode of the second guiding means reversely connected to the intermediate point lacking charges is conducting, said switch(es) of the second means positioned between the storage element and said conducting diode of the second means being closed, the other switches of the first and second guiding means being open, and

during the step for discharging the storage element, all the switches of the first and second guiding means are open,
the reference value is a predetermined value,
the method further comprises a step for measuring a balancing cycle time, and the reference value depends on the difference between the measured cycle time and a predefined cycle time value,
the reference value is increased when the difference between the measured cycle time and the predefined cycle time value is positive, the reference value is retained when the difference between the measured cycle time and the predefined cycle time value is zero, and the reference value is decreased when the difference between the measured cycle time and the predefined cycle time value is negative,
the method further comprises a timing step, during which the intermediate point from which are extracted the charges during the extraction step, is identical with the intermediate point to which the charges are injected during the injection step, the extraction step and the injection step being carried out simultaneously.

### BRIEF DESCRIPTION OF THE DRAWINGS

These features and advantages of the invention will become apparent upon reading the description which follows, only given as an example, and made with reference to the appended drawings, wherein:

FIG. 1 is a schematic illustration of a conversion system according to the invention;

FIG. 2 is an electric diagram of a module for balancing the voltage on the terminals of capacitors of the conversion system of FIG. 1;

FIG. 3 is an electric diagram of a module for switching the input DC voltage of the conversion system of FIG. 1;

FIG. 4 is a flow chart of the balancing method according to the invention;

FIG. 5 is an electric diagram similar to the one in FIG. 2 according to a second embodiment of the invention; and

FIG. 6 is an electric diagram similar to the one of FIG. 3 according to a third embodiment of the invention.

### DETAILED DESCRIPTION

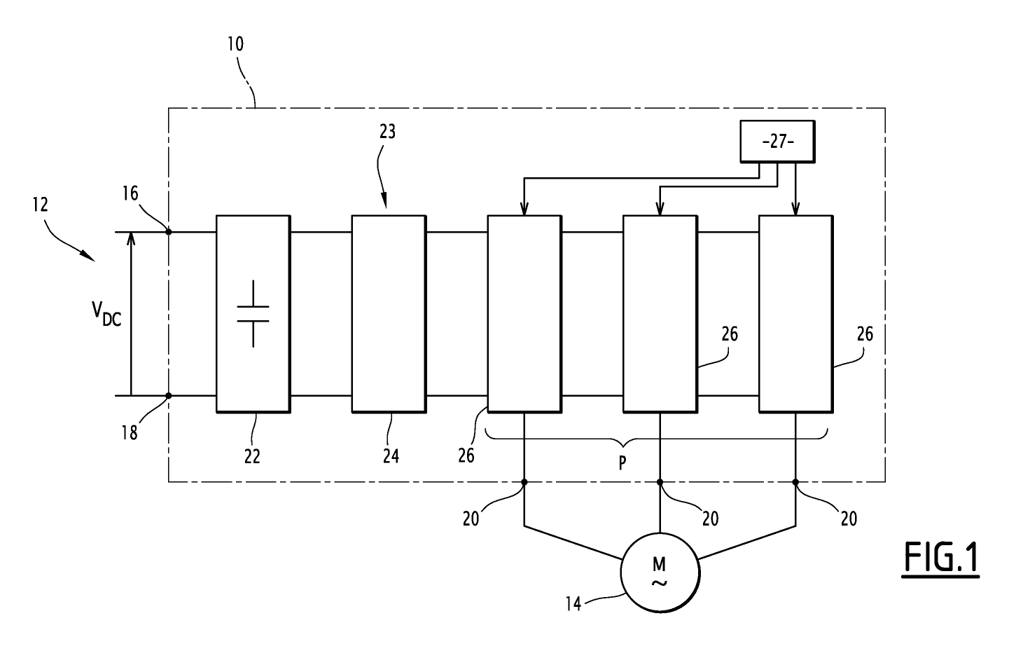

In FIG. 1, a conversion system 10, connected to a continuous input bus 12, is able to convert an input DC voltage into an output AC voltage including P phases and delivered to an electric machine 14 connected at the output of the conversion system. The conversion system 10 is a voltage inverter with N levels, wherein N is an integer greater than or equal to 3.

The conversion system 10 comprises a positive input terminal 16, a negative input terminal 18, and an output terminal 20 for each of the P phases. P is an integer greater than or equal to 1. In the exemplary embodiment of FIG. 1, P is equal to 3.

The conversion system 10 comprises a set 22 of capacitors, a device 23 for balancing the voltage on the terminals of at least one capacitor of the set, the balancing device 23 including a balancing module 24 for balancing said voltage, P modules 26 for switching the input DC voltage, and means 27 for controlling each switching module 26.

Alternatively, the balancing device 23 comprises several balancing modules 24 connected in parallel of the set of capacitors 22, such as for example a balancing module 24 for each switching module 26.

The DC voltage source 12 has an input DC voltage V_{DC} between the input terminals 16, 18 of the conversion system.

The electric machine 14 is for example a three-phase electric motor. The electric motor 14 is for example a synchronous motor. Alternatively, the motor 14 is an asynchronous motor.

The set of capacitors 22, the balancing module 24 and the P switching modules 26 are electrically connected in parallel on each other between the input terminals 16, 18. In other words, both input terminals 16, 18 are common to the set of capacitors 22, to the balancing device 23 and to the P switching modules 26. Each switching module 26 is also connected to a respective output terminal 20.

In the exemplary embodiment of FIG. 1, the balancing module 24 is mechanically laid out between the set of capacitors 22 and the switching modules 26.

Alternatively, the balancing module 24 is mechanically laid out between two switching modules 26. Still alternatively, the switching modules 26 are mechanically laid out between the set of capacitors 22 and the balancing module 24.

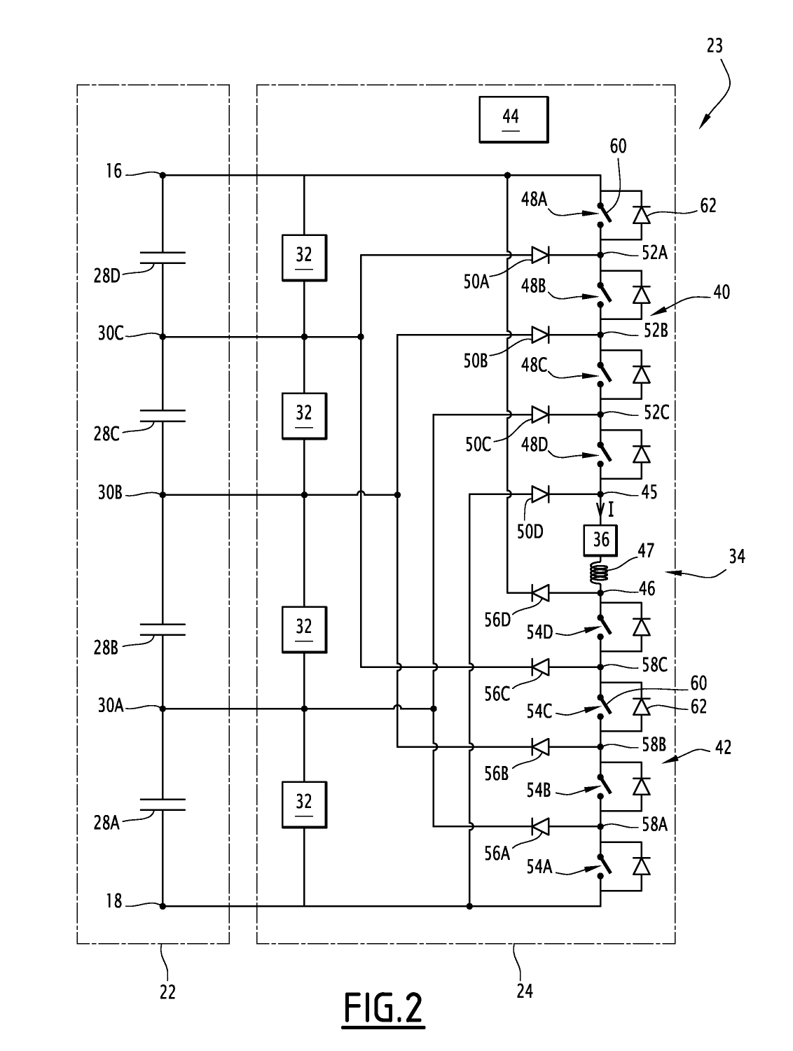

In FIG. 2, the set of capacitors 22 includes N−1 capacitors 28 connected in series between both input terminals 16, 18 and connected together through intermediate points 30. The capacitors 28 all have a same capacitance C. Alternatively, the capacitors 28 have different capacitances.

In the exemplary embodiment of FIG. 2, wherein N is equal to 5, the four capacitors 28 are respectively noted as 28A, 28B, 28C, 28D, in succession from the negative input terminal 18 as far as the positive input terminal 16, the intermediate points being respectively noted as 30A, 30B, 30C.

An extreme capacitor 28D is directly connected to the positive input terminal 16, and the other extreme capacitor 28A is directly connected to the negative input terminal 18.

The balancing module 24 includes means 32 for determining the amount of excess or lacking electric charges in each of the intermediate points 30, a temporary electric energy storage element 34, and means 36 for measuring the intensity of the current flowing in the temporary storage element. The balancing module 24 also includes first current guiding means 40 able to extract electric charges from an intermediate point 30 towards the temporary storage element 34, second current guiding means 42 able to inject electric charges from the temporary storage 34 towards an intermediate point 30.

The balancing module 24 also includes a member 44 for controlling the first and second guiding means 40, 42 able to control the first guiding means 40 so as to extract charges from at least one intermediate point 30 having an excess of charges and the second guiding means 42 so as to inject charges to at least one intermediate point 30 having a lack of charges.

The determination means 32 include means for measuring the voltage on the input terminals 16, 18 and in each of the intermediate points 30A, 30B, 30C. The determination means 32 are for example voltmeters connected to the terminals of each of the capacitors 28.

The temporary storage element 34 includes a first terminal 45, a second terminal 46, and an electromagnetic coil 47 of inductance L positioned between the terminals 45, 46.

The measurement means 36 are for example at an amperemeter connected in series with the temporary storage element 34.

The first guiding means 40 include N−1 switches 48 connected in series between the positive input terminal 16 and the first terminal 45 of the storage element, and N−1 diodes 50. The switches 48 are connected together through connection points 52, two extreme switches of the N−1 switches 48 being directly connected to one of the two terminals from among the positive terminal 16 and the first terminal 45 of the storage element. N−2 diodes 50 are forwardly connected between an intermediate point 30 and a respective connection point 52, and the last diode 50 is forwardly connected between the negative input terminal 18 and the first terminal 45 of the storage element.

In the exemplary embodiment of FIG. 2, wherein N is equal to 5, the 4 switches 48 are respectively noted as 48A, 48B, 48C, 48D in succession from the positive input terminal 16 as far as the first terminal 45 of the storage element. The 4 diodes 50 are also noted as 50A, 50B, 50C, 50D in succession from the closest connection point 52 to the positive input terminal 16 as far as the first terminal 45 of the storage element. In other words, the last diode is noted as 50D. The connection points are also noted 52A, 52B, 52C in succession from the positive terminals 16 as far as the first terminal 45 of the storage element.

The second guiding means 42 include N−1 switches 54 connected in series between the negative input terminal 18 and the second terminal 46 of the storage element, and N−1 diodes 56. The N−1 switches 54 are connected together through connection points 58, two extreme switches of the N−1 switches being directly connected to one of the two terminals from among the negative terminal 18 and the second terminal 46 of the storage element. N−2 diodes 56 are reversely connected between an intermediate point 30 and a respective connection point 58, and the last diode 56 is reversely connected between the positive input terminal 16 and the second terminal 46 of the storage element.

In the exemplary embodiment of FIG. 2, wherein N is equal to 5, the 4 switches 54 are respectively noted as 54A, 54B, 54C, 54D in succession from the negative input terminal 18 as far as the second terminal 46 of the storage element. By analogy, the 4 diodes 56 are noted as 56A, 56B, 56C, 56D in succession from the closest connection point 58 to the negative terminal 18 as far as the second terminal 46 of the storage element. The three connection points 58 are noted as 58A, 58B, 58C successively from the negative terminal 18 as far as the second terminal 46 of the storage element. In other words, the last diode is noted as 56D.

The switches 48, 54 of the first 40 and second 42 guiding means are for example bidirectional in current and in voltage. Each switch 48, 54 is a controllable electronic switch, and for example includes a transistor 60 and a diode 62 connected in anti-parallel to the transistor. The transistor 60 is for example an IGBT (Insulated Gate Bipolar Transistor) transistor. Alternatively, the transistor 60 is a MOSFET (Metal Oxide Semiconductor Field Effect Transistor) transistor.

Alternatively, each switch 48, 54 is a controllable electronic switch including a transistor, without the presence of a diode connected in anti-parallel to the transistor.

The control member 44 is connected to each of the controllable electronic switches 48, 54 and is able to send them respective control signals. The first terminal 45 of the temporary storage element is able to be connected to the positive terminal 16 via the first guiding means 40, and the second terminal 46 of the storage element is able to be connected to the negative terminal 18 via the second guiding means 42, until a current with a value greater than a reference value I_{ref} is established in the temporary storage element 34.

The reference value I_{ref} is for example substantially equal to the value of the current produced by the respective phase of a switching module 26. Generally, the reference value I_{ref} is substantially equal to the value of the current produced by an output phase of an electric energy conversion device able to be connected to the input terminals 16, 18 and to the intermediate points 30.

The reference value I_{ref} is for example a predetermined value. The predetermined reference value I_{ref} is for example equal to 2,000 A for a 10 MW conversion system having a voltage V_{DC} equal to 5 kV between its input terminals 16, 18.

Alternatively, the balancing device 23 includes means, not shown, for measuring a balancing cycle time TCm, and means, not shown for calculating the reference value I_{ref} depending on the difference between the measured cycle time TCm and a predefined cycle time value TC0. The predefined cycle time value TC0 is for example comprised between 50 μs and 100 ms, preferably comprised between 100 μs and 10 ms.

The calculation means are able to increase the reference value I_{ref} when the difference between the measured cycle time TCm and the predefined cycle time value TC0 is positive, and to decrease said reference value I_{ref} when the difference between the measured cycle time TCm and the predefined cycle time value TC0 is negative, said reference value I_{ref} being initially a predetermined value, for example equal to the value of the current which may be produced by the respective phase of a switching module 26. The reference value I_{ref} cannot be modified by the calculation means when the measured cycle time TCm is equal to the predefined cycle time value TC0.

The value of the inductance L of the electromagnetic coil 47 of the temporary storage element 34 is substantially equal to the value of the DC voltage V_{DC} between the input terminals 16, 18 multiplied by the minimum time of a balancing cycle and divided by the reference value I_{ref}.

The value of the inductance L is preferably comprised between 100 μH and 100 mH.

The value of the inductance L is for example equal to 10 mH for a voltage V_{DC} equal to 5 kV, a cycle time of 5 ms, and a reference value I_{ref} equal to 2,000 A. Alternatively, the value of the inductance L is for example equal to 300 μH for a voltage FIG. 2 equal to 6 kV, a cycle time of 100 μs, and a reference value I_{ref} equal to 2,000 A.

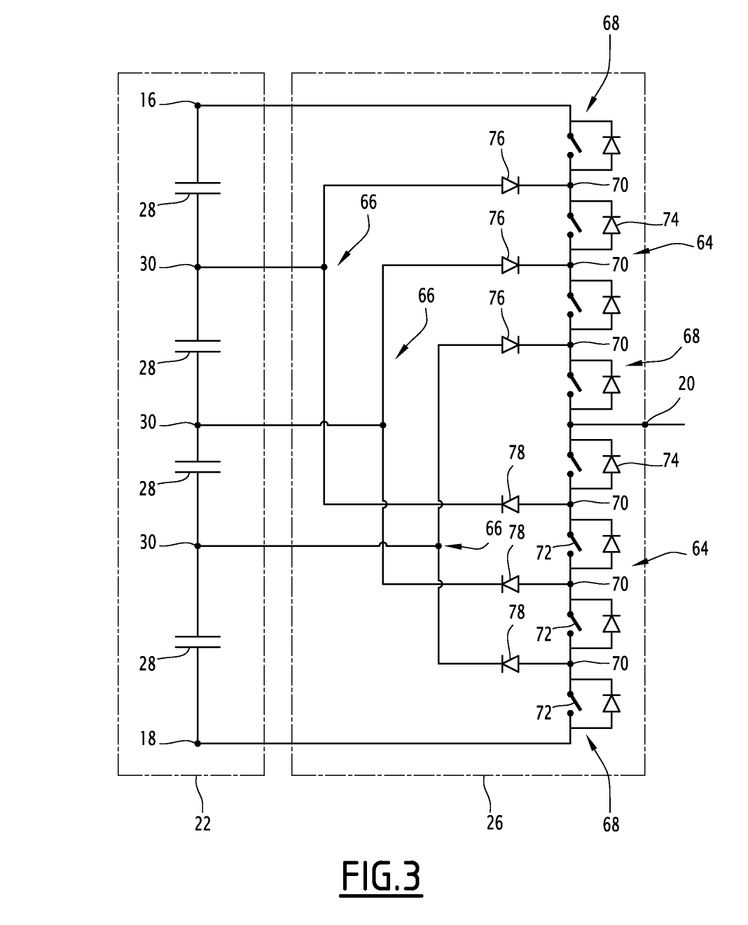

In FIG. 3, the switching module 26 comprises two extreme branches 64 and N−2 intermediate branches 66. The switching module 26 has a topology of the type clamped by the neutral, also called NPC (Neutral Point Clamped) topology.

Each extreme branch 64 is connected between a respective input terminal 16, 18 and the corresponding output terminal 20. Each extreme branch 64 includes N−1 switches 68 connected in series and connected together through middle points 70. Each switch 68 is for example a controllable electronic switch, bidirectional in current and in voltage, and includes a transistor 72 and a diode 74 connected in anti-parallel to the transistor. The transistor 72 is for example an IGBT transistor.

Each intermediate branch 66 is connected to a respective intermediate point 30 of the set of capacitors and includes two diodes 76, 78. The first diode 76 is forwardly connected between said respective intermediate point 30 and a respective middle point 70 of one of the two extreme branches 64, the second diode 78 being reversely connected between said respective intermediate point 30 and a middle point 70 of the other of the two extreme branches 64.

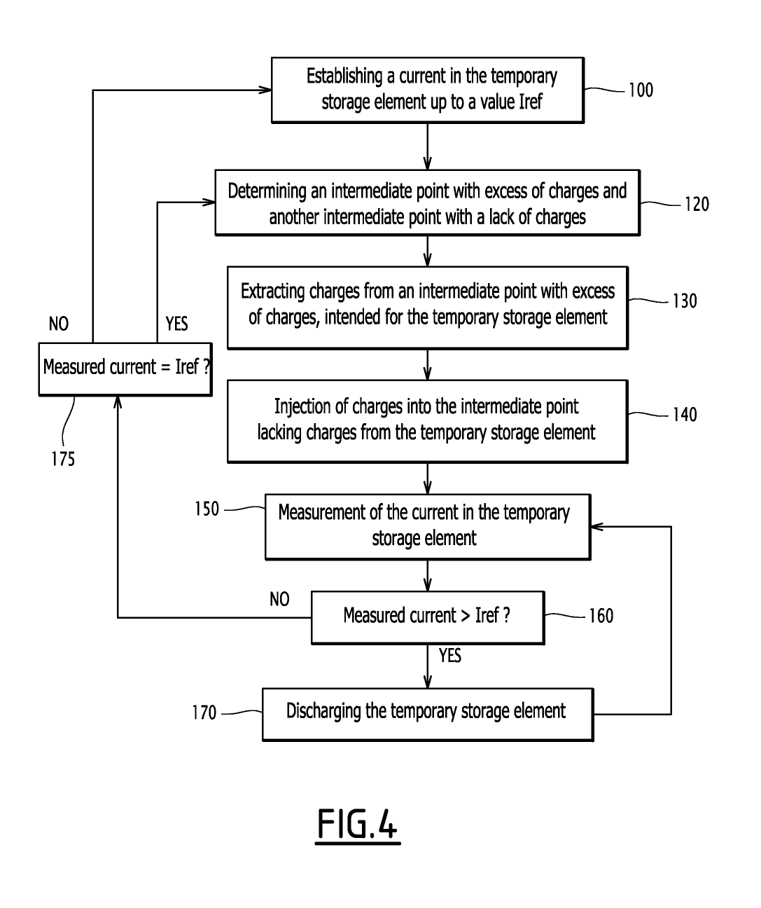

The operation of the balancing device 23 will now be explained by means of FIG. 4 illustrating a flow chart of a method for balancing the voltage on the terminals of a capacitor 28 of the set of capacitors.

The control member 44 begins by establishing a current I in the temporary storage element 34 until the value of said current I is equal to the reference value I_{ref}, by controlling the closing of all the switches 48, 54 of the first 40 and second 42 guiding means, during step 100. The first terminal 45 of the storage element is then connected to the positive terminal 16, and the second terminal 46 of the storage element is connected to the negative terminal 18.

During the establishment step 100, the measurement means 36 regularly measure the intensity of the current I flowing in the temporary storage element 34, and transmit this measurement of the current Ito the control member 44 in order to determine the instant when the current attains the reference value I_{ref}, i.e. determine the instant up to which the closing of all the switches 48, 54 has to be ordered.

At the end of the establishment step 100, the determination means 32 then measure during step 120 the voltage on each of the input terminals 16, 18 and in each of the intermediate points 30, also called a node j, wherein j is an integer comprised between 0 and 4. By convention, the node 0 corresponds to the negative terminal 18, the nodes 1, 2, 3 respectively correspond to the intermediate points 30A, 30B, 30C, and the node 4 corresponds to the positive terminal 16. The offset of charges in each intermediate point 30 with respect to equilibrium is represented by a respective variable ΔQj, determined according to the formula hereafter:

ΔQj=C×[(Vⱼ₊₁−Vⱼ)−(Vⱼ−Vⱼ₋₁)] (1)

wherein Vj represents the voltage at node j, j varying between 1 and 3.

The variables ΔQ1, ΔQ2, ΔQ3 respectively correspond to the nodes 1, 2, 3 i.e. to the intermediate points 30A, 30B, 30C.

When the variable ΔQj is positive, then the intermediate point 30 corresponding to the node j has an excess of electric charges, and when the variable ΔQj is negative, the intermediate point 30 corresponding to the node j has a lack of electric charges.

The determination means 32 then determine the intermediate point 30 having an excess of electric charges, the intermediate points 30 having a lack of electric charges, as well as the optional intermediate points 30 for which the voltage is balanced, for which the variable ΔQj is zero.

Electric charges are then extracted, during step 130, at the intermediate points 30 with an excess of charges, so as to be guided towards the temporary storage element 34.

The charges received by the temporary storage element 34 are injected into the intermediate points 30 lacking charges during step 140.

During step 130, respectively during step 140, the determination means 32 also measure the voltage at the respective intermediate points 30, in order to determine the amount of charges remaining in excess, respectively remaining in lack, or else determine the instant when said respective intermediate points 30 are in charge equilibrium in order to pass to the next step.

The extraction of charges from an intermediate point 30 with an excess and/or the injection of charges to as far as an intermediate point 30 with a lack via the temporary storage element 34 during steps for extracting charges 130 and/or for injecting charges 140 are carried out via the control member 44 sending control signals to the switches 48, 54 in order to control the switches 48, 54 according to a predefined sequential law.

The sequential law is such that, during the step for extracting charges 130, the diode of the first guiding means 40, forwardly connected to the intermediate point in excess is conducting, said switch(es) of the first means 40 positioned between said conducting diode of the first means and the storage element 34 being closed. The other switches of the first guiding means 40 are open.

The sequential law is also such that, during the step for injecting charges 140, the diode of the second guiding means 42 reversely connected to the intermediate point in lack is conducting, said switch(es) of the second means 42 positioned between the storage element 34 and said conducting diodes of the second means being closed. The other switches of the second guiding means 42 are open.

The sequential law for opening the switches is for example opening the switches in the following order, 48A, 48B, 48C, 48D, respectively 54A, 54B, 54C, 54D. The instant of opening of the different switches 48, 54 depends on the amount of charges to be transferred from or towards the corresponding node.

The sequential law for opening the switches is such that the opening of the second guiding means 42 begins simultaneously with that of the first guiding means 40. Alternatively, the sequential law for opening the switches is such that the opening of the second guiding means 42 begins in succession of that of the first guiding means 40.

Alternatively, the sequential opening law is the opening of the switches according to the following order 54A, 54B, 54C, 54D, respectively 48A, 48B, 48C, 48D. Still alternatively, the sequential opening law is according to the following order 48A, 54A, and then 48B, 54B, and then 48C, 54C, and then 48D, 54D. Still alternatively, the sequential opening law is according to the following order 54A, 48A, and then 54B, 48B, and then 54C, 48C, and then 54D, 48D.

At the end of the extraction 130 and/or injection 140 steps, a measurement of the current flowing in the temporary storage element 34 is carried out by the measurement means 36 during step 150. This current measurement is transmitted to the control member 44.

The control member 44 then compares the value of the measured current with the reference value I_{ref}.

If the value of the current measure during the measurement step 150 is greater than the reference value I_{ref}, a discharge of the temporary storage element 34 is then carried out during step 170 by the control member 44 which controls the opening of all the switches 48, 54. If the value of the current measured during step 150 is on the contrary less than or equal to the reference value I_{ref}, the control member 44 tests, during step 175, whether the value of the measured current is equal to the reference value I_{ref}.

If necessary, the intermediate points 30 with an excess of charges, as well as those with a lack of charges, are again determined during step 120. Otherwise, i.e. if the value of the measured current is strictly less than the reference value I_{ref}, then the control member 44 again controls the closing of all the switches 48, 54 until a current is established in the temporary storage element 34 having an intensity of a value equal to the reference value I_{ref} (step 100).

As an example, assuming that the intermediate point 30C is lacking in charges and that the intermediate point 30A is in excess of charges, then the switches 48, 54 are for example controlled in the way described hereafter.

At the end of the establishment step 100, the control member 44 controls the opening of the switches 48A, and 54A. This first state with the sole switches 48A and 54A is of short duration and depends on the switching time of the switches 48A, 54A, since it is not necessary to extract charges from the intermediate point 30C or inject charges towards the intermediate point 30A.

The control member 44 then controls the opening of the switches 48B and 54B, the switches 48A and 54A being always open. This second state is also of short duration and depends on the switching time of the switches 48B, 54B, since it is not necessary to extract charges from the intermediate point 30B or inject charges towards the intermediate point 30B.

The control member 44 then controls the opening of the switches 48C and 54C, the switches 48A, 48B, 54A and 54B being always open. By opening the switch 48C, only the switch 48D of the first means remaining closed, it is possible to extract charges from the intermediate point 30A towards the temporary storage element 34, this state being maintained for the time required for extracting the excess charges. In a similar way, by opening the switch 54C, only the switch 54D of the second means remaining closed, it is possible to inject charges from the temporary storage element 34 towards the intermediate point 30C, this state being maintained for the time required for injecting the lacking charges.

It should be noted that the time for maintaining the opening of the switch 48C, only the switch 48D of the first means remaining closed, is different from the time for maintaining the opening of the switch 54C, only the switch 54D of the second means remaining closed, from the moment that the amount of excess charges at the intermediate point 30A differs from the amounts of lacking charges at the intermediate point 30C.

The control member 44 finally controls the opening of the switches 48D and 54D, the switches 48A, 48B, 48C, 54A, 54B and 54C being always open. This state corresponds to a state of discharge of the temporary storage element 34, and is only maintained if the value of the current measured in the temporary storage element 34 is greater than the reference value I_{ref}. If the value of the current measured in the temporary storage 34 is on the contrary less than the reference value I_{ref}, then the state of discharge is of a duration as short as possible and depends on the switching time of the switches 48D and 54D from their opening position to their closing position.

At the end of this discharge state of the temporary storage element 34, the control member 44 controls the closing of the switches 48D and 54D, for a short duration if the intermediate points 30A and 30C are always in charge equilibrium following the balancing carried out previously, or else for a duration required for extracting the excess charges, respectively for injecting the lacking charges, if the intermediate point 30A is again with an excess of charges, respectively if the intermediate point 30C is again lacking charges.

The control member 44 then controls the closing of the switches 48C and 54C for a short duration, the switches 48D and 54D being always closed, and then the closing of the switches 48B and 54B also for a short duration, the switches 48D, 48C, 54D and 54C being always closed, and finally the closing of the switches 48A and 54A in order to return into the initial state where all the switches 48, 54 are closed.

The switches 48, 54 remain closed for a short duration if the value of the current measured in the temporary storage element 34 is greater than or equal to the reference value I_{ref}. If the value of the current measured in the temporary storage element 34 is on the contrary less than the reference value I_{ref}, then the closing state of the switches 48, 54 is of a duration corresponding to the time for establishing the current in the temporary storage element 34 up to the reference value I_{ref}.

The method is then repeated in the case of a new excess or lack of charges in an intermediate point 30.

In the exemplary embodiment of FIG. 4, the balancing of the voltage on the terminals of a corresponding capacitor is obtained in one cycle, corresponding to the successive execution of the steps 100 to 150.

In the exemplary embodiment of FIG. 4, the reference value I_{ref} is a predetermined value.

Alternatively, the reference value I_{ref} depends on the difference between the measured cycle time TCm and the predefined cycle time value TC0. By convention, the measured cycle time TCm is equal to the time interval between two successive test steps 175.

The predefined cycle time value TC0 is for example, comprised between 50 μs and 100 ms, preferably comprised between 100 μs and 10 ms.

The method then further comprises a step, not shown, for calculating the reference value I_{ref}. The reference value I_{ref} is increased when the difference between the measured cycle time TCm and the predefined cycle time value TC0 is positive, and the reference value I_{ref} is decreased when the difference between the measured cycle time TCm and the predefined cycle time value TC0 is negative. The reference value I_{ref} is not modified when the measured cycle time TCm is equal to the predefined cycle time value TC0.

Additionally, the method further comprises a timing step, not shown, during which the intermediate point from which are extracted the charges during the extraction step 130 is identical with the intermediate point towards which charges are injected during the injection step 140, the extraction step 130 and the injection step 140 being carried out simultaneously. With the timing step it is thus possible to modify the value of the measured cycle time TCm.

In other words, the reference value I_{ref} is servo-controlled depending on the value of the measured cycle time TCm, this value being itself controllable via the timing step.

The balancing device according to the invention thus allows balancing of the voltage on the terminals of each of the capacitors connected between the input terminals regardless of the voltage and of the current delivered by the conversion device able to be connected between the input terminals.

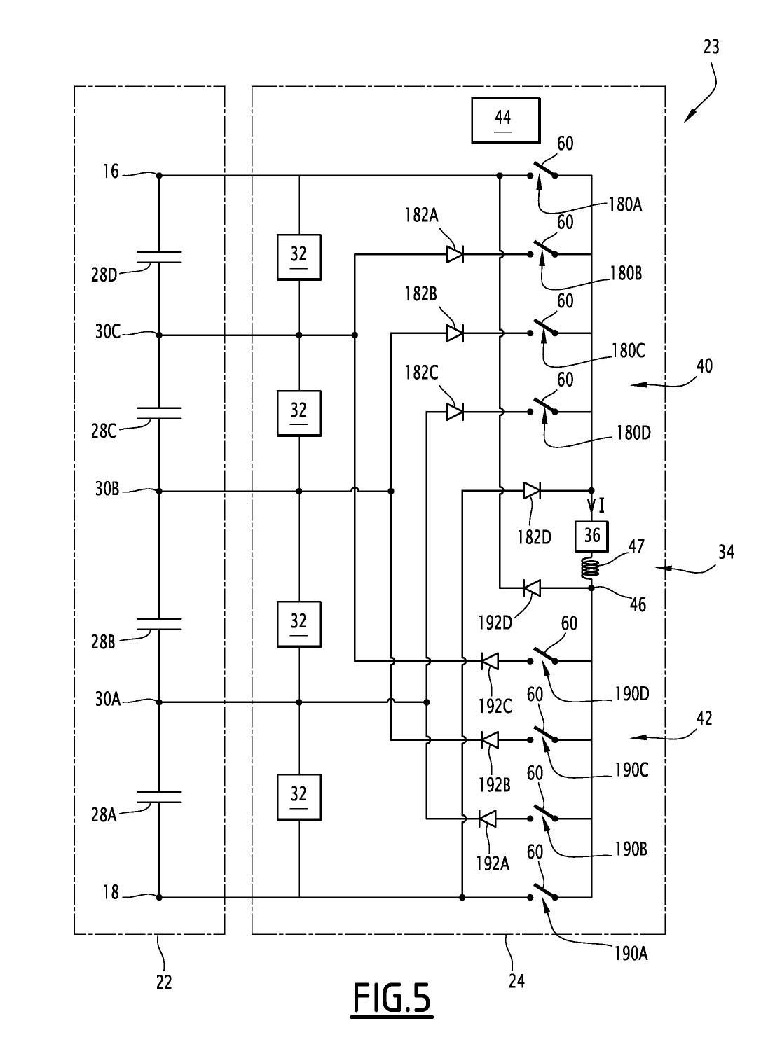

FIG. 5 illustrates a second embodiment of the invention for which the elements similar to the first embodiment, described earlier, are marked with identical references, and are therefore not described again.

According to the second embodiment, the first guiding means 40 include N−1 switches 180 connected in parallel between the first terminal 45 of the storage element and a point from among the positive input terminal 16 and the intermediate points 30, and N−1 diodes 182. N−2 diodes 182 are connected in series with said switches 180 connected between the first terminal 45 of the storage element and the intermediate points 30 and directly between the intermediate points 30 and the first terminal 45. The last diode 182 is forwardly connected between the negative input terminal 18 and the first terminal 45 of the storage element.

In the exemplary embodiment of FIG. 5, wherein N is equal to 5, the 4 switches 180 are respectively noted as 180A, 180B, 180C, 180D successively from the positive input terminal 16 as far as the first terminal 45 of the storage element. The 4 diodes 182 are also noted as 182A, 182B, 182C, 182D successively from the intermediate point 30C as far as the negative input terminal 18. The last diode is noted as 182D.

The second guiding means 42 include N−1 switches 190 connected in parallel between the second terminal 46 of the storage element and a point from among the negative input terminal 18 and the intermediate points 30, and N−1 diodes 192. N−2 diodes 192 are connected in series with said switches 190 connected between the second terminal 46 of the storage element and the intermediate point 30 and in reverse between the intermediate points 30 and the second terminal 46. The last diode 192 is reversely connected between the positive input terminal 16 and the second terminal 46 of the storage element.

In the exemplary embodiment of FIG. 5, wherein N is equal to 5, the 4 switches 190 are respectively noted as 190A, 190B, 190C, 190D successively from the negative input terminal 18 as far as the second terminal 46 of the storage element. By analogy, the 4 diodes 192 are noted as 192A, 192B, 192C, 192D successively from the intermediate point 30A as far as the positive input terminals 16. The last diode is noted as 192D.

The switches 180, 190 of the first 40 and second 42 guiding means are for example bidirectional in current and in voltage. Each switch 180, 190 is a controllable electronic switch and for example includes a transistor 60 and a diode 62 connected in anti-parallel to the transistor. The transistor 60 is for example an IGBT (Insulated Gate Bipolar Transistor) transistor. Alternatively, the transistor 60 is a MOSFET (Metal Oxide Semiconductor Field Effect Transistor) transistor.

Alternatively, each switch 180, 190 is a controllable electronic switch including a transistor, without the presence of a diode connected in anti-parallel to the transistor.

The control member 44 is connected to each of the controllable electronic switches 180, 190 and is able to send them respective control signals.

The operation of this second embodiment is similar to the one of the first embodiment, and is therefore not described again.

The advantages of this second embodiment are identical with those of the first embodiment, and are therefore not described again.

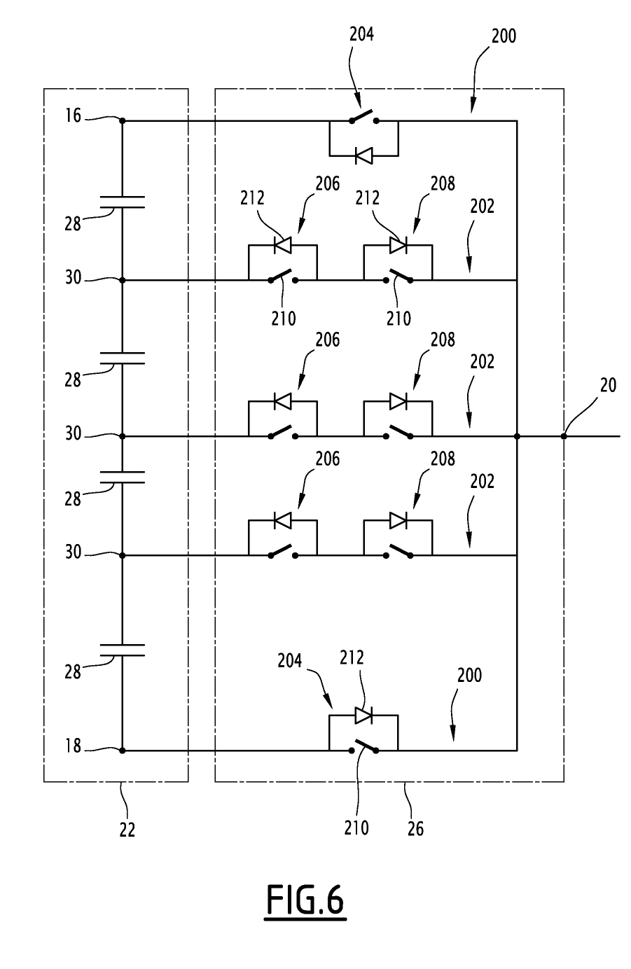

FIG. 6 illustrates a third embodiment of the invention for which the elements similar to the first embodiment, described earlier, are marked with identical references and are therefore not described again.

According to the third embodiment, the switching module 26 has a topology of the type controlled by the neutral, also called NPP (Neutral Point Piloted) topology.

The switching module 26 then includes two extreme branches 200 and N−2 intermediate branches 202. Each extreme branch 200 is connected between a respective input terminal 16, 18 and the corresponding output terminal 20, and includes a controllable electronic switch 204.

Each intermediate branch 202 is connected between a respective intermediate point 30 of the set of capacitors and said output terminals 20, and includes two switches 206, 208 connected in anti-series.

Each switch 204, 206, 208 is for example a controllable electronic switch, bidirectional in current and voltage, including a transistor 210 and a diode 212 connected in anti-parallel to the transistor. The transistor 210 is for example an IGBT transistor.

The operation of this third embodiment is identical as regards the balancing device 23, with that of the first embodiment, and is therefore not described again.

The advantages of this third embodiment are identical, as regards the balancing device 23, with those of the first embodiment, and are therefore not described again.

It is thus realized that the balancing device according to the invention allows balancing of the voltage on the terminals of each of the capacitors of the set of capacitors regardless of the voltage and the current delivered by the conversion device able to be connected between the input terminals.

What is claimed is:

1. A device for balancing the voltage on the terminals of at least one capacitor of a set of capacitors, said set of capacitors comprising a positive input terminal, a negative input terminal, N−1 capacitors connected in series between both input terminals and connected together through intermediate points, two extreme capacitors) of the N−1 capacitors being directly connected to one of the two input terminals, N being greater than or equal to 3, both input terminals and the intermediate points being able to be connected to an electric energy conversion device which may cause an unbalance of the voltage on the terminals of at least one capacitor,
wherein said balancing device comprises at least one module for balancing the voltage on the terminals of each of the N−1 capacitors, the balancing module being connected between both input terminals and including means for determining the amount of excess or lacking charges in each of the intermediate points, a temporary electric energy storage element including two terminals, first current guiding means able to extract electric charges from an intermediate point towards a terminal of the temporary storage element, second current guiding means able to inject electric charges from the other terminal of the temporary storage element towards an intermediate point and a control member for the first and second guiding means, able to control the first guiding means so as to extract charges from at least one intermediate point having an excess of charges and the second guiding means so as to inject the charges to at least one intermediate point having a lack of charges, and
in that a terminal of the temporary storage element is able to be connected to the positive input terminal, respectively to the negative input terminal via the first guiding means and the other terminal of the temporary storage element is able to be connected to the negative input terminal respectively to the positive input terminal, via the second guiding means, in order to increase, respectively decrease, the energy stored in the temporary storage element.

2. The balancing device according to claim 1, wherein the temporary storage element includes at least one electromagnetic coil.

3. The balancing device according to claim 1, wherein each of the first and second guiding means includes N−1 switches and N−1 diodes.

4. The balancing device according to claim 3, wherein the switches of the first means are connected in series between the positive input terminal and a terminal of the storage element, and connected together through connection points, two extreme switches of the N−1 switches being directly connected to one of the two terminals from among the positive terminal and the terminal of the storage element, N−2 diodes of the first means are forwardly connected between a respective intermediate point and a respective connection point, and the other diode of the first means is forwardly connected between the negative input terminal and the terminal of the storage element, and
wherein the switches of the second means are connected in series between the negative input terminal and the other terminal of the storage element, and connected together through connection points, two extreme switches of the N−1 switches being directly connected to one of the two terminals from among the negative terminal and the other terminal of the storage element, N−2 diodes of the second means are reversely connected between a respective intermediate point and a respective connection point of the second means and the other diode of the second means is reversely connected between the positive input terminal and the other terminal of the storage element.

5. The balancing device according to claim 3, wherein the switches of the first means are connected in parallel between the terminal of the storage element and a point from among the positive input terminal and the intermediate points, N−2 diodes of the first means are connected in series with said switches connected between the terminal of the storage element and the intermediate points and forwardly between the intermediate points and the terminal, and the other diode of the first means is forwardly connected between the negative input terminal and the terminal of the storage element, and
the switches of the second means are connected in parallel between the other terminal of the storage element and a point from among the negative input terminal and the intermediate points, N−2 diodes of the second means are connected in series with said switches connected between the other terminals of the storage element and the intermediate points and reversely between the intermediate points and the other terminal, and the other diode of the second means is reversely connected between the positive input terminal and the other terminal of the storage element.

6. The balancing device according to claim 1, wherein the means for determining the amount of excess or lacking charges include means for measuring the voltage on the input terminals and on each of the intermediate points.

7. A system for converting an input DC voltage into an output AC voltage including at least one phase, comprising:
a positive input terminal, a negative input terminal, and an output terminal for said or each phase;
a set of capacitors including N−1 capacitors connected in series between both input terminals and connected together through intermediate points, two extreme capacitors of the N−1 capacitors being directly connected to one of the two input terminals, N being greater than or equal to 3;
for each output terminal, a module for switching the input DC voltage, each switching module being connected between both input terminals and the respective output terminal, and being able to convert the input DC voltage into the respective phase of the output AC voltage,
means for controlling each switching module;
wherein it comprises a balancing device according to claim 1, the balancing device being connected between both input terminals.

8. The conversion system according to claim 7, wherein the switching module comprises two extreme branches and N−2 intermediate branches, wherein each extreme branch is connected between a respective input terminal and said output terminal, and includes N−1 switches connected in series and connected together through middle points, and wherein each intermediate branch is connected to a respective intermediate point and includes two diodes, the first diode being forwardly connected between said respective intermediate point and a respective middle point of one of the two extreme branches, and the second diode being reversely connected between said respective intermediate points and a respective middle point of the other one of the two extreme branches.

9. The conversion system according to claim 7, wherein the switching module comprises two extreme branches and N−2 intermediate branches, wherein each extreme branch includes a switch connected between a respective input terminal and said output terminal, and wherein each intermediate branch includes two switches connected in anti-series between a respective intermediate point and said output terminal.

10. A method for balancing the voltage on the terminals of at least one capacitor of a set of capacitors via a device for balancing said voltage,
said set of capacitors comprising a positive input terminal, a negative input terminal, N−1 capacitors connected in series between both input terminals and connected together through intermediate points, two extreme capacitors of the N−1 capacitors being directly connected to one of the two input terminals, N being greater than or equal to 3, the two input terminals and the intermediate points being able to be connected to an electric energy conversion device which may cause an unbalance of the voltage on the terminals of at least one capacitor,
the balancing device comprising at least one balancing module connected between both input terminals and including means for determining the amount of excess or lacking charges in each of the intermediate points, a temporary electric energy storage element including two terminals, first current guiding means able to extract electric charges from an intermediate point towards a terminal of the temporary storage element, and second current guiding means (able to inject electric charges from the other terminal of the temporary storage elements towards an intermediate point,
the method comprising:
a step for establishing a current in the temporary storage element until the value of said current is greater than a reference value, during which a terminal of the temporary storage element is connected to the positive input terminal via a corresponding control of the first guiding means, the other terminal of the temporary storage element being connected to the negative input terminal via a corresponding control of the second guiding means;
a step for determining an intermediate point with an excess of electric charges and/or another intermediate point lacking electric charges;
a step for extracting charges from the intermediate point with an excess of charges to the temporary storage element, via a corresponding control of the first guiding means; and/or
a step for injecting charges into the intermediate point lacking charges from the temporary storage element, via a corresponding control of the second guiding means;
a step for measuring the current in the temporary storage element at the end of at least one step for extracting (and/or injecting charges; and
a step for discharging the temporary storage element when the value of the current measured during the measurement step is greater than that of the reference value.

11. The balancing method according to claim 10, wherein each of the first and second guiding means includes N−1 switches and N−1 diodes,
the switches of the first means being connected in series between the positive input terminal and a terminal of the storage element, and connected together through connection points, two extreme switches of the N−1 switches being directly connected to one of the two terminals from among the positive terminals and the terminal of the storage element, N−2 diodes of the first means being forwardly connected between a respective intermediate point and a respective connection point of the first means, and the other diode of the first means being forwardly connected between the negative input terminal and the terminal of the storage element, and
the switches of the second means being connected in series between the negative input terminal and the other terminal of the storage element, and connected together through connection points, two extreme switches of the N−1 switches being directly connected to one of the two terminals from among the negative terminals and the other terminal of the storage element, N−2 diodes of the second means being reversely connected between a respective intermediate point and a respective connection point of the second means, and the other diode of the second means being reversely connected between the positive input terminal and the other terminal of the storage element,
wherein, during the initial step for establishing the current in the temporary storage element, all the switches of the first and second guiding means are closed,
wherein, during the step for extracting the charges, the diode of the first guiding means forwardly connected to the intermediate point with an excess of charges is conducting, the switch(es) of the first means positioned between said conducting diode of the first means and the storage element being closed, the other switches of the first and second guiding means being open,
wherein, during the step for injecting charges, the diode of the second guiding means reversely connected to the intermediate point lacking charges is conducting, said switch(es) of the second means positioned between the storage element and said conducting diode of the second means being closed, the other switches of the first and second guiding means being open, and
wherein, during the step for discharging the storage element, all the switches of the first and second guiding means are open.

12. The balancing method according to claim 10, wherein the reference value is a predetermined value.

13. The balancing method according to claim 10, further comprising a step for measuring a balancing cycle time, wherein the reference value depends on the difference between the measured cycle time and a predefined cycle time value.

14. The balancing method according to claim 13, wherein the reference value is increased when the difference between the measured cycle time and the predefined cycle time value is positive, wherein the reference value is retained when the difference between the measured cycle time and the predefined cycle time value is zero, and wherein the reference value is decreased when the difference between the measured cycle time and the predefined cycle time value is negative.

15. The balancing method according to claim 10, further comprising a timing step, during which the intermediate point from which are extracted the charges during the extraction step is identical with the intermediate point towards which the charges are injected during the injection step, the extraction step and the injection step being carried out simultaneously.
